(19) United States
(12) Patent Application Publication
(10) Pub. No.: US 2009/0201503 A1
(43) Pub. Date: Aug. 13, 2009

(54) Torsion Sensor

(75) Inventors: Ian Bennion, Ravensthorp (GB); Kaiming Zhou, Birmingham (GB); Xianfeng Chen, Birmingham (GB); Lin Zhang, Solihull (GB)

Correspondence Address: SWANSON & BRATSCHUN, L.L.C., 8210 SOUTHPARK TERRACE, LITTLETON, CO, 80120, US

(73) Assignee: ASTON UNIVERSITY, Birmingham (GB)

(21) Appl. No.: 12/306,240

(22) PCT Filed: Jul. 9, 2007
(86) PCT No.: PCT/GB07/02547

§ 371 Date: Feb. 27, 2009

(30) Foreign Application Priority Data
Jul. 13, 2006 (GB) 0613958.8

(51) Int. Cl. G01J 4/00; G02B 6/00

(52) U.S. Cl. 356/370; 385/13

(57) ABSTRACT

A torsion sensor using an optical waveguide in optical communication with a diffraction grating, preferably a tilted grating, and most preferably a tilted Bragg grating, which provides the optical waveguide and grating with a torsion-dependent collective optical transmission spectrum. Changes in the collective optical transmission spectrum of the waveguide and grating, induced by changes in the amount of torsion applied to the waveguide, may be detected by detecting a corresponding change in the intensity of optical radiation transmitted through the grating from a controlled optical source. The degree of change in the collective optical transmission spectrum is dependent upon the degree of torsion (twist) applied to the optical waveguide. Measuring the magnitude and/or sense (i.e. increase/decrease) in the intensity of optical radiation transmitted through the grating from an optical source enables torsion to be sensed.

The present invention relates to methods and apparatus for sensing twist or torsion in an optical waveguide, such as an optical fibre.

Torsion in objects such as buildings, vehicles and engineering works, or any component of them may be detrimental to the structural integrity of the object. The detection or monitoring of torsion, or changes in torsion, in such structures may assist in determining deformation, stresses or strains in objects and structures. Also, the monitoring or detection of rotational changes in relative position between two parts of an object, such as a machine or other dynamic structure, is an apparently simple task which may become complex and/or expensive to maintain for extended periods of time The present invention aims to provide a cheap, reliable and simple, yet sensitive and accurate torsion sensor and method of torsion detection, useable for any of these and other purposes.

At its most general, the invention proposed is to sense torsion using an optical waveguide in optical communication with (e.g. containing) a diffraction grating, preferably a tilted grating, and most preferably a tilted Bragg grating, which provides the optical waveguide and grating with a torsion-dependent collective optical transmission spectrum. Changes in the collective optical transmission spectrum of the waveguide and grating, induced by changes in the amount of torsion applied to the waveguide, may then be detected by detecting a corresponding change in the intensity of optical radiation transmitted through the grating from a known or controlled optical source. It has been found that the degree of change in the collective optical transmission spectrum is predictably dependent upon the degree of torsion (twist) applied to the optical waveguide, and the invention may include measuring the magnitude and/or sense (i.e. increase/decrease) in the intensity of optical radiation transmitted through the grating from an optical source. The torsion-dependence of the collective optical transmission spectrum of the optical waveguide and grating has been found to be sensitively dependent upon the state of polarisation of optical radiation it transmits and, preferably, the invention may include apparatus for, or the step of, transmitting through the optical waveguide optical radiation which is other than un-polarised—preferably having some degree of linear polarisation.

Accordingly, in a first of its aspects, the present invention may provide a torsion sensor for detecting torsion including a tilted Bragg grating (e.g. a tilted fibre Bragg grating), an optical waveguide (e.g. an optical fibre) arranged to guide optical radiation to the tilted Bragg grating (e.g. containing the grating), an optical radiation means for providing polarised optical radiation and arranged to input the polarised optical radiation to the optical waveguide for guidance thereby to the tilted Bragg grating, and an optical detector arranged to detect optical radiation transmitted through the tilted Bragg grating from the optical radiation means and arranged to detect torsion in the optical waveguide according to the intensity of the detected optical radiation. In this way, a detected intensity, or change in the intensity, of optical radiation transmitted through the optical waveguide and the tilted Bragg grating, may detect a corresponding torsion, or change in torsion, in the optical waveguide. When the optical waveguide is fixed or attached to another body or structure, other than the torsion sensor or a part of it, a component of any twist or torsion of the body or structure which imparts a torsion or twist in the attached optical waveguide, may be detected by the torsion sensor. The optical waveguide is preferably straight along the part of it used for sensing torsion. The optical waveguide may be a length of optical fibre, which may be held straight or arrangeable to be so held. Torsion detectable by the optical waveguide may be torsion about the longitudinal axis of the waveguide. Preferably, the optical radiation means is arranged, or operable, to input to the optical waveguide optical radiation of a substantially constant intensity, or of an intensity which is variable, or varies, in a known or predetermined way, such that changes in the detected intensity level of transmitted optical radiation detectable by the optical detector, may be determined as being in direct correspondence with a change in the amount of torsion to which the optical waveguide is subject, and/or be distinguishable/separable from changes in input optical intensity levels.

The optical detector may comprise any suitable optical detection arrangement responsive to receipt thereby of optical radiation to produce a detection signal (e.g. electrical signal) indicating such receipt. The detection signal may be of a signal strength not in any proportion to the intensity of received optical radiation—and so may serve as a simple indicator/alarm of a detected chance in torsion. The optical detector may produce a detection signal only in response to detection of optical radiation having an intensity level exceeding (or falling below) a pre-set threshold value. Alternatively, the optical detector may be responsive to optical radiation received thereby to produce a detection signal having a strength/magnitude (or other measurable quality) in proportion to the level of intensity so received. In this way, the optical detector may be arranged to produce an optical detection signal which provides a measure of the intensity of transmitted optical radiation received by thereby. The detector may be arranged to produce a measure of any torsion present in the optical waveguide according to the measure/amount of detected intensity of the transmitted polarised optical radiation. The tilted Bragg grating may be contained within (e.g. formed within) the optical waveguide. The optical waveguide may be an optical fibre, such as a clad optical fibre, and the tilted Bragg grating may be formed in the core part of the clad fibre as a tilted fibre Bragg grating.

The optical detector may include a signal processor unit (e.g. a DSP, or computer, such as a PC), responsive to detection signals to calculate/determine therefrom the measure of torsion present in the optical waveguide. This calculation or determination may include employing pre-determined calibration data stored in (or accessible by) the signal processor unit, which convey a relationship (e.g. empirical) between the transmission (or transmission coefficient) of the optical waveguide and Bragg grating collectively, and the degree of torsion to which the waveguide is subject. From this relationship, the signal processor unit may be operable or arranged to correlate detected intensity levels of transmitted optical radiation, with a specific pre-calibrated torsion value thereby to determine said measure as being equal to that the correlated pre-calibrated torsion value. The optical detector may contain source-intensity data representing the intensity of optical radiation which the optical radiation means is arranged to input to the optical waveguide, or may be arranged in communication with the optical radiation means to receive such data therefrom. The optical radiation source may then be arranged to normalise detection signals produced thereby, using the source-intensity data such that the magnitude of the former may become substantially insensitive to changes in the magnitude of the latter.

A Bragg grating is distinguishable for another type of optical grating, such as a long-period grating, in that it is structured to diffract incident radiation in such a way as to effectively act as a generally reflective body. Conversely, a long-period grating is structured to diffract incident radiation in such a way as to effectively act as a generally transmissive body. When formed within a body, such gratings may be defined by a series of distinct regions of modulation (increase/decrease) in the refractive index of the medium within which the grating is formed—which are commonly known as grating “fringes” or “planes”. For example, when the grating is within a waveguide (e.g. an optical fibre), each of these regions defines an area/zone of material in the path of guided radiation, which has a differing refractive index and is optically distinct from the contiguously adjoining material. This induces a degree of local reflection of radiation, as well as some transmission. Interference between a plurality of such reflections and transmissions within the grating structure, arising at successive grating fringes, determines transmission/reflection spectral properties of the grating structure as a whole—i.e. whether it is generally reflective or transmissive as a whole. Commonly, grating fringes in a waveguide structure are substantially flat in shape and are oriented such that they directly face in a direction parallel to the longitudinal axis (e.g. transmission axis) of the waveguide. However, the grating fringes of tilted gratings differ in that they are oriented to face in a direction oblique to the longitudinal axis of the waveguide, thereby to be “tilted” relative to that axis. The tilt angle of a tilted grating may be the angle subtended between the line perpendicular to the plane (or median plane) of an (or each) grating fringe, and the longitudinal (or transmission) axis of the waveguide at the grating fringe.

In the present invention, the tilted Bragg grating may have a tilt angle exceeding 45 degrees. Preferably, the angle of tilt exceeds about 65 degrees, and may be about 81 degrees or more. It has been found that the collective optical transmission spectrum of the optical waveguide and Bragg grating is particularly sensitive to levels of applied torsion when the angle of tilt of the tilted Bragg grating exceeds this value (e.g. 65 degrees). This arrangement preferentially diffracts a proportion of optical radiation entering the grating, in to optical modes of propagating differing and separable from those optical modes which entered the grating. However, tilt angles of less than 45 degrees (but exceeding zero degrees) are also possible. For example, the optical waveguide may be a clad structure (e.g. a clad optical fibre) having a core part clad by a distinct cladding part. The tilted Bragg grating may be located in the core part of the optical waveguide. The optical waveguide may be a clad optical fibre, and the titled Bragg grating may be a titled fibre Bragg grating. An angle of tilt of the Bragg grating exceeding 45 degrees is effective in coupling optical radiation received in core modes of propagation, into distinct cladding modes of propagation which co-propagate (i.e. in the same direction) as the core modes from which they derive. The loss of optical radiation from the core mode(s) into the cladding modes manifests itself as a transmission attenuation resonance (i.e. a trough) in the transmission spectrum of the optical waveguide and Bragg grating, the resonance being centred upon a particular optical wavelength determined by structural (e.g. dimensions and materials) of the waveguide and the grating. Optical radiation from cladding modes is typically rapidly lost from the optical waveguide by processes of absorption and scattering from the cladding material—and the optical waveguide is preferably structured (e.g. of a sufficient length/material) to ensure this—leaving substantially only (or mainly) core modes of radiation to be detected by the optical detector having been transmitted through the tilted Bragg grating (unlike the cladding modes, which have not). The optical detector (or the torsion sensor as a whole) may be arranged to receive/detect only core-mode radiation from the optical waveguide. The depth and position of the transmission attenuation resonance has been found to be sensitively dependent upon the level of torsion to which the optical waveguide is subject during polarised radiation transmission thereby.

The optical radiation source may be arranged to produce the optical radiation in a linearly polarised state. The optical radiation is preferably completely linearly polarised (i.e. substantially all photons sharing a common state/orientation of polarisation), and while the degree of linear polarisation of the optical radiation may be less than complete—but the greater the degree of linear polarisation, the better (e.g. at least two in every three photons sharing a common polarisation axis).

The tilted Bragg grating may have a plurality of grating fringes and the optical radiation means may be arranged to input to the optical fibre linearly polarised optical radiation oriented such that the axis of polarisation thereof is substantially parallel to the grating fringes of the tilted Bragg grating as when the optical waveguide is in an untwisted (torsion-free) state (quiescent) state.

Alternatively, the optical radiation means may be arranged to input to the optical waveguide linearly polarised optical radiation oriented such that the axis of polarisation thereof is tilted relative to the grating fringes by an angle substantially equal in size to the angle of tilt to the grating fringes as when the optical waveguide is in the quiescent state.

It has been found that the collective optical transmission spectrum of the optical waveguide and Bragg grating displays a highly torsion-sensitive optical transmission attenuation resonance (i.e. a trough region) the minimum of which is lowest when the polarisation state of the optical radiation in question is one of the above two states. The attenuation resonance(s) become deepest as maximal radiation out-coupling from the grating occurs. This permits a relatively large torsion detection range and sensitivity.

The optical waveguide, collectively with (e.g. containing) the tilted Bragg grating, may be structured and arranged to have an optical transmission spectrum possessing an attenuation resonance, such as described above, and the optical radiation means may be arranged to produce substantially monochromatic optical radiation having a wavelength (or at least a narrow bandwidth) lying within the wavelength bandwidth of the transmission attenuation resonance. In this way, the depth of the optical waveguide's transmission attenuation resonance, either at its centre or elsewhere within the resonance, is sensitively dependent upon the degree of torsion to which the waveguide is subject during radiation transmission through the tilted Bragg grating. A torsion-induced change in the depth of the part of the transmission attenuation resonance corresponding to the position of the wavelength/waveband of radiation from the optical radiation source, will result in a corresponding change in detected intensity at the optical detector, thereby indicating sensitively the change in torsion within the optical waveguide. Preferably, the wavelength/waveband of the optical output of the optical radiation means contains, or is centred upon, the wavelength at which a transmission attenuation resonance of the optical waveguide is centred or minimised.

The collective transmission spectrum of the waveguide and tilted Bragg grating, has been found to change depending upon the state of polarisation (e.g. orientation of linear polarisation) of optical radiation being transmitted thereby. It has been found that a broad transmission attenuation resonance (e.g. core-mode-to-cladding-mode when in a clod waveguide) is displayed with a trough/minimum split into two closely spaced sub-minima or sub-resonances, when optical radiation is randomly polarised (i.e. un-polarised). When the state of polarisation of the optical radiation is in either one of two mutually orthogonal states of linear polarisation (such as one of those states identified above with reference to the Bragg grating), then a single transmission attenuation resonance may be displayed corresponding to one of the two sub-resonances occurring under random polarisation. The wavelength at which the single attenuation resonance (or sub-resonance) is positioned within the collective transmission spectrum of the waveguide and Bragg grating, coincides with that of either one of the two sub-minima/resonances (present in respect of un-polarised radiation) depending, respectively, upon which one of the two orthogonal states of polarisation is employed in the optical radiation. It has been found that the collective optical transmission spectrum of the waveguide and grating develops an additional transmission attenuation resonance (i.e. a sub-resonance, another trough) adjacent to, and spaced from, that present in the absence of torsion. The spacing between the positions (wavelengths) at which each of the two transmission attenuation sub-resonances are respectively minimal, has been found to vary predictably in dependence upon the degree of torsion to which the optical waveguide is subject. The sub-resonances are coupled in the sense that a reduction in the depth of one, as a result of changing torsion, occurs as the depth of the other increases—and vice versa. The two sub-resonances collectively split a broader main resonance of which they each form a part when both are present.

In the torsion sensor, the optical detector may be arranged to determine the resonance wavelength of the optical radiation at which transmission thereof through the optical waveguide and Bragg grating is minimised at each of two separate transmission attenuation resonances thereof. The optical detector may be arranged to detect torsion in the optical waveguide according to a change in either resonance wavelength so determined. The optical detector may be arranged to produce a measure of the torsion in the optical waveguide according to the difference in the resonance wavelengths so determined.

In order to enable the torsion sensor to detect torsion in an object—such as a structure of a building, and engineering work, a vehicle, ship or aircraft, or any component of them—the torsion sensor may include fixing means with which parts of the optical waveguide may be fixed to an object to enable torsion in the object to be transferred to the optical waveguide. The torsion sensor may include two separate fixing means attached (e.g. fixed) to the optical waveguide (e.g. at opposite sides of the tilted Bragg grating) between the optical radiation source and the optical detector thereby to define between them an intermediate length of said optical waveguide (e.g. containing the tilted Bragg grating). The each/either of the fixing means may be a clamp, frame or grip of suitable such design as would be readily apparent to the skilled person, which clamps/grips the optical waveguide and/or which is adapted to clamp/grip to an object. Each one of the two fixing means may be adapted to be simultaneously fixed independently to an object(s) other than the optical waveguide whereby a torsion in the object(s) may result in a torsion in the intermediate length of optical waveguide.

The two fixing means of the torsion sensor may be rotatably joined to each other, with one fixing means being rotatable relative to the other about the longitudinal axis of the optical waveguide to which both are attached e.g. fixed. The torsion sensor may include a body portion to which each of the two fixing means is attached, with at least one of the two fixing means being rotatable relative to the other fixing means about the longitudinal axis of the intermediate length of optical waveguide between them. Preferably, the body portion holds the two fixing means apart by a separation equal to the intermediate length of optical waveguide between them. Preferably, the length of optical waveguide contains the tilted Bragg grating and is in a state of axial tension. The fixing means are preferably positioned, or positionable, upon the body portion to achieve this state of tension. The body portion may be a rod, bar, arm, frame or tube joined to the two fixing means. The body part may be a tube, duct or conduit enveloping at least a part of the optical waveguide (e.g. the part containing the grating) and along the internal bore of which the optical waveguide extends. This may protect the optical waveguide. It is preferable that at least one (e.g. both) of the two fixing means is exposed thereby to enable it to be attached to an object being sensed.

In a second of its aspects, the present invention may provide a torsion sensor as described above in the first embodiment of the invention, attached to an object. The sensor, so attached, may include two separate fixing means attached (e.g. fixed) to the optical waveguide (e.g. at opposite sides of the tilted Bragg grating) between the optical radiation source and the optical detector thereby to define between them an intermediate length of said optical waveguide (e.g. containing the tilted Bragg grating). One of, or each one of, the two fixing means may be fixed to a respective object (e.g. simultaneously fixed independently to parts of the same object) such that a positional twist/rotation between the objects/parts or a torsion in the object about the axis of the intermediate length of optical waveguide may result in a torsion in the intermediate length of optical waveguide.

In a third of its aspects, the present invention may provide an arrangement including a torsion sensor according to the invention in its first aspect, arranged such that a length of the optical waveguide (e.g. containing the tilted Bragg grating) is embedded in an object whereby a torsion in the object about the axis of the length of optical waveguide may result in a torsion in the length of optical waveguide.

Thus, the invention in its second and third aspects realises an application of the present invention as a torsion sensor arranged to sense torsion in an object being either attached thereto or being embedded therein to enable torsion in the object to be transferred to the optical waveguide. The object may be a structural part of a building, an engineering work (e.g. a viaduct, column, pole or frame), a vehicle, ship or aircraft, a natural object (e.g. a tree) or any component of them. Consequently, the invention may be applied to passively detect, monitor or measure torsion in any such object.

The tilted Bragg grating may be located in the optical waveguide midway along the intermediate length of optical waveguide. In other embodiments, the Bragg grating may be positioned at (or immediately adjacent to) one end of the intermediate length of optical waveguide—such as the end optically closest to the optical detector and optically furthest from the optical radiation source—i.e. the end from which optical radiation is output having passed through the Bragg grating. The latter arrangement achieves greater torsion sensitivity for a given intermediate length of optical waveguide.

As discussed above, when subject to torsion, the collective optical transmission spectrum of the optical waveguide and tilted Bragg grating may display a main transmission attenuation resonance split by two separate, coupled and adjacent transmission attenuation sub-resonances. The depth of each of the two coupled attenuation sub-resonances change in relatively opposite senses in response to changes in torsion applied to the optical waveguide. Preferably, the torsion sensor is arranged such that the optical waveguide is held in a predetermined state of torsion about its long (transmission) axis. Where the torsion sensor includes the aforesaid fixing means, these may serve to hold the intermediate length of optical waveguide in said predetermined state of torsion. Alternatively, where the optical waveguide is embedded in an object, it may be embedded in said predetermined state of torsion. The two separate fixing means may be arranged maintain the intermediate length of optical waveguide in a state of torsion in the absence of external torsion.

Preferably, the predetermined state of torsion is such that an increase in the torsion in the optical waveguide (e.g. application of an external torsion) results in only one of: a corresponding increase, or; a corresponding decrease, in the transmission spectrum thereof (through the tilted Bragg grating) at the wavelength of optical radiation falling within the bandwidth of a sub-resonance (e.g. it's centre, or resonance wavelength) and/or falling within the bandwidth of radiation which the optical radiation means is arranged to generate. Correspondingly, in these two circumstances, respectively, a decrease in the torsion in the optical waveguide (e.g. application of an external torsion) preferably results in only one of: a corresponding decrease, or; a corresponding increase, in the transmission spectrum thereof (through the grating) at the wavelength of optical radiation falling within the bandwidth of a sub-resonance (e.g. it's centre, or resonance wavelength) and/or falling within the bandwidth of radiation which the optical radiation source is arranged to generate. As a result of this pre-torsioning, the torsion sensor not only becomes more sensitive to detection of applied torsion but is able to determine the sense/direction of further torsion (e.g. twist direction) applied thereto. For example, a further torsion which adds to the pre-torsion may result in a rise in the transmission spectrum at the relevant optical wavelength which, in turn, results in a corresponding rise in the detected intensity of transmitted optical radiation at the optical detector. Alternatively, a further torsion which subtracts from the pre-torsion would then result in a fall in detected intensity of transmitted optical radiation at the optical detector. Given knowledge of the sense/direction of the pre-torsion, the sense of the change of intensity of transmitted optical radiation detected by the optical detector enables knowledge of the sense of the further torsion. The optical detector may include signal processing means operable or arranged to determine the sense/direction of further torsion applied to the pre-torsioned optical waveguide according to the sense of change in intensity of transmitted optical radiation detected thereby.

Preferably, the value if the pre-torsion (T₀) is preferably equal to the torsion (T_{EQUAL}) which causes each of two aforementioned sub-resonances, splitting a common transmission attenuation resonance in the collective optical transmission spectrum of the fibre and grating, to be substantially equal in depth. The value of the pre-torsion may be a value selected from the range

0.9T_{EQUAL}<T₀<1.1T_{EQUAL}, or the range 0.8T_{EQUAL}<T₀<1.2T_{EQUAL}, or the range 0.7T_{EQUAL}<T₀<1.3T_{EQUAL}, or the range 0.6T_{EQUAL}<T₀<1.4T_{EQUAL}, or the range 0.5T_{EQUAL}<T₀<1.5T_{EQUAL}, or the range 0.4T_{EQUAL}<T₀<1.6T_{EQUAL}, or the range 0.3T_{EQUAL}<T₀<1.7T_{EQUAL}.

Preferably, the magnitude of the pre-torsion is a value between 10 degrees and 170 degrees, more preferably between 20 degrees and 160 degrees, yet more preferably between 30 degrees and 150 degrees, yet more preferably between 40 degrees and 140 degrees, yet more preferably between 50 degrees and 130 degrees, yet more preferably between 60 degrees and 120 degrees, yet more preferably between 70 degrees and 110 degrees, yet more preferably between 80 degrees and 100 degrees. Most preferably, the pre-torsion is 90 degrees. The pre-torsion here is expressed in terms of the rotational displacement, from a torsion-free position, of one end of the optical waveguide relative to the other about the longitudinal axis of the optical waveguide.

The optical detector may be arranged to detect the intensity of transmitted polarised optical radiation having a wavelength at which transmission thereof through the tilted Bragg grating is minimised at each of two separate optical transmission attenuation sub-resonances in the collective optical transmission spectrum of the optical waveguide and tilted Bragg grating. The optical detector may be arranged to detect torsion in the optical waveguide according to the two intensities so detected. In this way, the intensity of transmitted radiation at each of two transmission attenuation sub-resonances (which may or may not correspond to the same main transmission attenuation resonance) may be employed to determine torsion in the optical waveguide displaying those sub-resonances (collectively with the tilted Bragg grating).

The optical detector may be arranged to detect torsion in the optical waveguide according to a difference between the two intensities so detected, or according to a ratio of the two intensities so detected. For example, the two sub-resonances employed for this purpose preferably are those which have relatively opposite responses to the application of torsion to the waveguide. Thus, when the ratio of the two detected intensities increases (or decreases), or when it exceeds (or falls below) a predetermined value, then this may be used to indicate the direction/sense of externally applied torsion to which the waveguide is subject. The optical detector is preferably arranged to make this determination and indication.

Each of the two separate optical transmission attenuation resonances may form one of a pair of coupled sub-resonances splitting a main optical transmission attenuation resonance. For example, the main resonance may be common to both sub-resonances. Alternatively, each of the two separate said sub-resonances may be associated with separate respective main resonance.

One of the separate sub-resonances may be one of a first pair of sub-resonances splitting a first main optical transmission attenuation resonance and may be the sub-resonance of the first pair which occurs at an optical wavelength less than the optical wavelength at which occurs the other sub-resonance of the first pair. The other of the separate sub-resonances may be one of a second pair of sub-resonances splitting a second main optical transmission attenuation resonance and may be the sub-resonance of the second pair which occurs at an optical wavelength greater than occurs the optical wavelength at which occurs the other sub-resonance of the second pair. In this way, sub-resonances associated with different main resonances may be used, being chosen such that they display opposite responses (e.g. change in depth and/or position) in response to a given torsion in the waveguide displaying those main, and sub-, resonances in its transmission spectrum (collective with the tilted Bragg grating).

It will be appreciated that the invention as described above in its first, second and third aspects, realises a corresponding method of detecting torsion. That method is encompassed in the present invention.

In a fourth of its aspects, the present invention may provide a method of detecting torsion including,
providing an optical waveguide (e.g. optical fibre) and (e.g. containing) a tilted Bragg grating e.g. a titled fibre Bragg grating;
inputting polarised optical radiation to the optical waveguide for guidance thereby to the tilted Bragg grating;
detecting the intensity of said polarised optical radiation transmitted through the tilted Bragg grating; and,
detecting torsion in the optical waveguide according to the detected intensity of said transmitted polarised optical radiation. The method may include producing a measure of any torsion present in the optical waveguide according to the level of detected intensity of transmitted polarised optical radiation.

In the method, the tilted Bragg grating may be provided with a tilt angle exceeding 45 degrees, or between 65 degrees and 81 degrees or more. The optical radiation input to the optical waveguide may be in a linearly polarised state.

The method may include providing the tilted Bragg grating with a plurality of grating fringes, and inputting to the optical waveguide linearly polarised optical radiation oriented such that the axis of polarisation thereof is substantially parallel to the grating fringes of the tilted Bragg grating as when the optical waveguide is in the quiescent state. Alternatively, the method may include inputting to the optical waveguide linearly polarised optical radiation oriented such the axis of polarisation thereof is tilted relative to the grating fringes by an angle substantially equal in size to the angle of tilt of the grating fringes as when the optical waveguide is in the quiescent state.

The method may include determining the wavelength of the optical radiation at which transmission thereof through the tilted Bragg grating is minimised, and detecting torsion in the optical waveguide according to a change in said wavelength so determined. The method may include determining the wavelength positions of transmission minima associated with two concurrent optical transmission attenuation resonances of the optical waveguide and tilted Bragg grating collectively, and producing a measure of the torsion in the optical waveguide according to the difference in said wavelength positions so determined.

The optical waveguide and tilted Bragg grating collectively may have an optical transmission spectrum possessing an attenuation resonance, and the step of inputting polarised optical radiation to the optical waveguide may include inputting thereto substantially monochromatic optical radiation having a wavelength within the bandwidth of the attenuation resonance.

The method may include concurrently and independently fixing to an object (or two separate objects, or two separate parts of the same object) two separated parts of the optical waveguide (e.g. which are located at opposite sides of the tilted Bragg grating if the waveguide contains the tilted Bragg grating) thereby to define between those parts an intermediate length of said optical waveguide (e.g. containing the tilted Bragg grating), and subsequently detecting a positional twist or torsion in the object(s), or parts thereof, about the axis of the intermediate length of optical waveguide according to a detected torsion in the intermediate length of optical waveguide.

The tilted Bragg grating may be located in the optical waveguide midway along the intermediate length of optical waveguide or is preferably at or adjacent the optical output end of thereof. The method may include arranging the intermediate length of optical waveguide in a state of torsion of a predetermined magnitude.

The method may include embedding in an object a length of the optical waveguide (e.g. containing the tilted Bragg grating), and detecting a torsion in the object about the axis of the length of optical waveguide according to a detected torsion in the length of optical waveguide.

The optical waveguide may be an optical fibre, and the titled Bragg grating may be provided therein as a tilted fibre Bragg grating.

The method may include detecting the intensity of transmitted polarised optical radiation having a wavelength at which transmission thereof through the tilted Bragg grating is minimised at each of two separate optical transmission attenuation resonances in the collective optical transmission spectrum of the optical waveguide and tilted Bragg grating. The method may include detecting torsion in the optical waveguide according to the two intensities so detected.

The method may include detecting torsion in the optical waveguide according to a difference between the two intensities so detected, or according to a ratio of the two intensities so detected.

Each of the two separate optical transmission attenuation resonances may form one of a pair of coupled sub-resonances splitting a main optical transmission attenuation resonance. The main resonance may be common to both said sub-resonances. Alternatively, each of the two separate sub-resonances may be associated with separate respective main resonance.

One of the separate sub-resonances may be one of a first pair of sub-resonances splitting a first main optical transmission attenuation resonance and may be the sub-resonance of the first pair which occurs at an optical wavelength less than the optical wavelength at which occurs the other sub-resonance of the first pair, and the other of the separate sub-resonances may be one of a second pair of sub-resonances splitting a second main optical transmission attenuation resonance and may be the sub-resonance of the second pair which occurs at an optical wavelength greater than occurs the optical wavelength at which occurs the other sub-resonance of the second pair.

Non-limiting examples of the invention are described below with reference to the accompanying drawings in which:

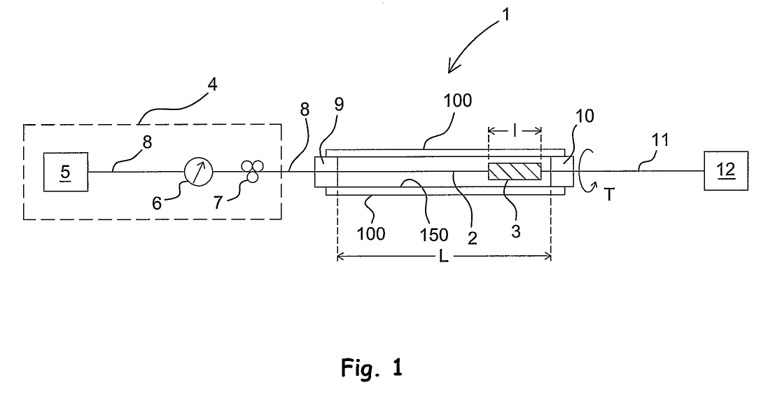

FIG. 1 schematically illustrates a torsion sensor;

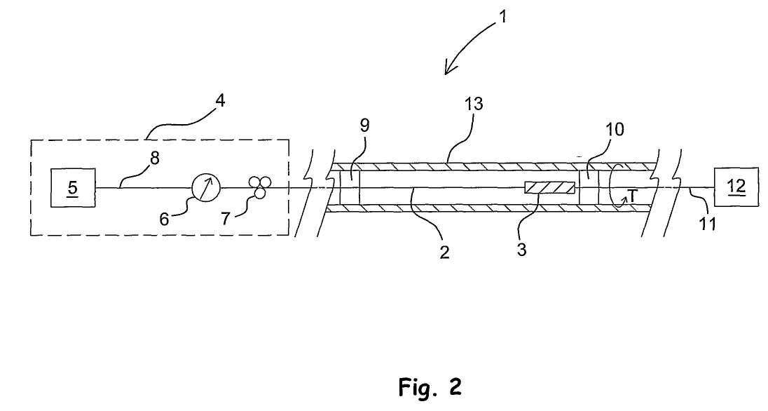

FIG. 2 schematically illustrates an object to which the torsion sensor of FIG. 1 is fixed, in use, such that a torsion T may be detected and/or measured thereby;

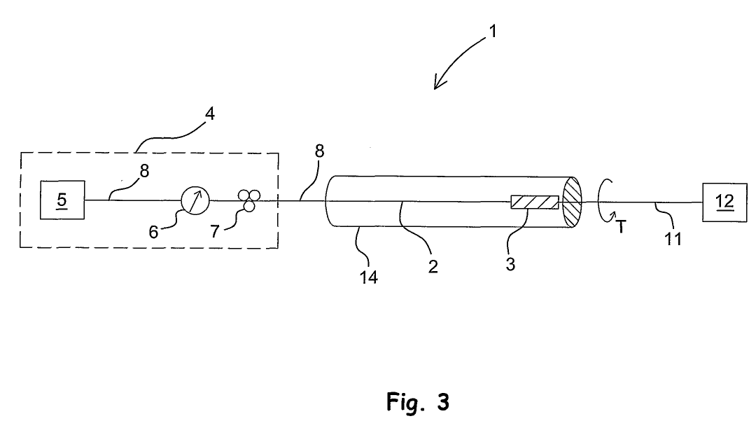

FIG. 3 schematically illustrates an object within which a part of the torsion sensor of FIG. 1 is embedded to enable the torsion sensor to detect and/or measure a torsion T in the object;

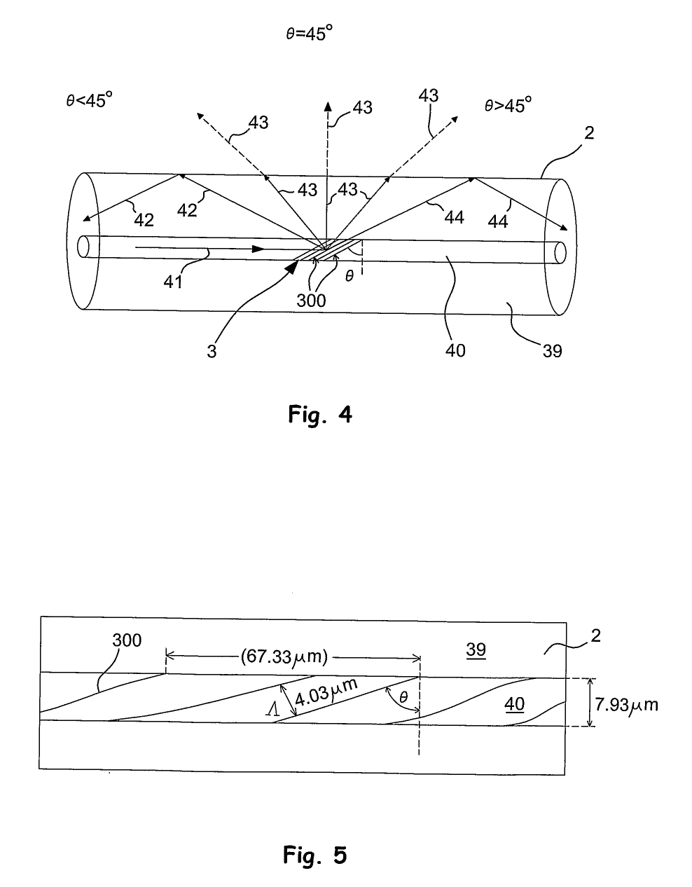

FIG. 4 schematically illustrates a tilted fibre Bragg grating within the core part of a clad optical fibre, together with optical diffraction modes according to various angles of tilt of the grating planes of the fibre Bragg grating;

FIG. 5 schematically illustrates an image of a tilted fibre Bragg grating within the core part of a clad optical fibre;

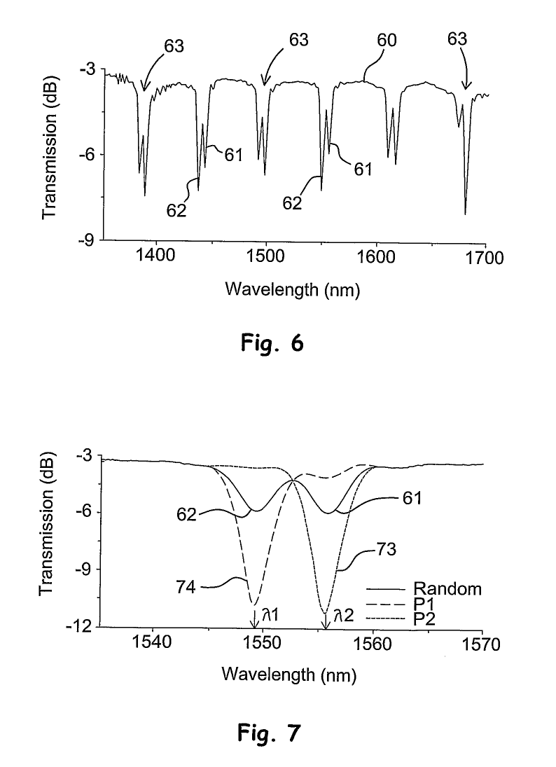

FIG. 6 graphically illustrates the transmission spectrum, as a function of optical radiation wavelength, of optical radiation transmitted by the optical fibre schematically illustrated in FIG. 4 containing a tilted fibre Bragg grating as illustrated in FIG. 5;

FIG. 7 graphically illustrates optical transmission spectra of an optical fibre such as is schematically illustrated in FIG. 4, containing a tilted fibre Bragg grating as illustrated in FIG. 5, as a function of the wavelength of optical radiation having three different states of polarisation;

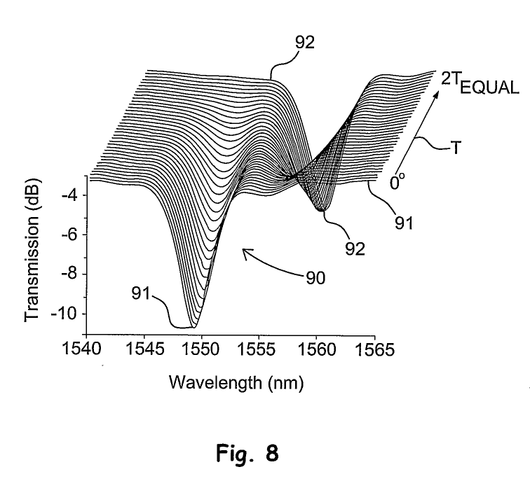

FIG. 8 graphically illustrates a series of optical transmission spectra, as a function of optical wavelength, associated with the optical fibre of the torsion sensor illustrated in FIG. 1, for a multitude of twist angles applied thereto;

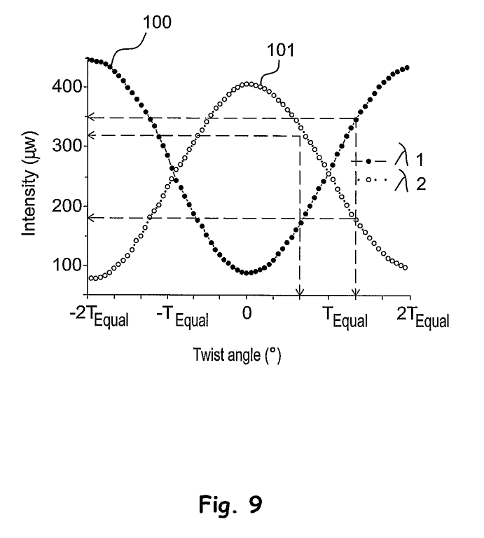

FIG. 9 graphically illustrates the intensity of transmitted optical radiation detected by the torsion sensor illustrated in FIG. 1 at a specific wavelength of optical radiation and as a function of varying twist angle applied to the optical fibre of the torsion sensor, for two different wavelengths of the optical radiation input to the optical fibre.

In the drawings, like articles are assigned like reference symbols.

FIG. 1 schematically illustrates a torsion sensor according to an example of the present invention, for detecting torsion in an optical fibre. The torsion sensor 1 includes a length L of single-mode clad optical fibre 2 containing a tilted fibre Bragg grating 3 located in the core part of the clad optical fibre 2 positioned immediately adjacent the optical output end of the length L of optical fibre. The tilted fibre Bragg grating 3 possesses grating fringes tilted by an angle of about 81 degrees relative to the direction perpendicular to the longitudinal axis of the optical fibre 2 in which it is formed. The length L of the tilted fibre Bragg grating 3 is centred upon the midpoint of the greater length I of the optical fibre 2 within which it is situated.

The torsion sensor further includes an optical radiation means 4 arranged to provide polarised optical radiation and to input that radiation to an end of the optical fibre 2 with which it is in nearmost optical communication. In nearmost optical communication with an opposite end of the optical fibre 2 is an optical detector unit 12 arranged to detect the intensity of polarised optical radiation transmitted through the tilted Bragg grating 3 of the optical fibre, from the optical radiation means 4.

The torsion sensor further includes two separate fixing units (9, 10) fixed to the optical fibre 2 at opposite sides of the tilted fibre Bragg grating 3, and are positioned between the optical radiation means 4 and the optical detector unit 12. Between them, the two separate fixing means (9, 10) define the length L of the optical fibre 2 containing the tilted fibre Bragg grating 3. Each one of the two fixing units (9, 10) is adapted to be fixed to an object(s) whereby a torsion in, or between, the object(s) about the axis of the length L of the optical fibre results in a torsion in the length of optical fibre which may be detected by the optical detector unit 12 as discussed in more detail below. The two fixing units are attached to a support conduit 100 along the internal bore 150 of which the optical fibre extends, and at opposite terminal ends of which a respective one of the two fixing means (9,10) is attached. The fixing unit 9 optically nearmost the optical radiation source is rigidly fixed to the support conduit, while the fixing means optically nearmost the optical detector 12 is mounted upon the support conduit to be freely rotatable about an axis collinear with the longitudinal axis of the optical fibre 2. Parts of both of the two fixing units (9,10) are exposed from the ends of the support conduit to enable those exposed parts to be fixed to an object(s). Torsion between the two points of fixture may then be sensed.

In alternative embodiments, the support conduit may be dispensed with. For example, each of the two fixing units (9, 10) may be adapted or adaptable to be fixed at spaced positions inside an object in respect of which torsion is to be sensed, such as a tube or pipe 13, such as is schematically illustrated in cross-section in FIG. 2. The fixing units may comprise blocks, lugs or frames of rigid material dimensioned to fit within the inner bore of the tube or pipe 13, in an interference fit with the inner bore surface thereof, or to urge against that surface. In alternative arrangements, the fixing unit (9, 10) may simply comprise surfaces, elements or components arranged to be adhered, screwed, locked or otherwise fixed rigidly in position to a body in respect of which a torsion is to be sensed by the torsion sensor, such as is schematically illustrated in FIG. 2. In alternative embodiments, the fixing unit (9, 10) may be dispensed with, and the length L of optical fibre 2 may be embedded in either the surface of, or the body of, an object such as a column, rod or pole of material (e.g. concrete, rubber or plastic) such as is schematically illustrated in FIG. 3 in respect of such an object 14. The objects (13, 14) in respect of which the torsion sensor 1 is arranged to sense a torsion T, may form, or form a part of, a structure of a building, or a vehicle (e.g. a land vehicle, ship or aircraft), or a civil structure such as a bridge.

Referring to FIG. 1, the optical radiation means 4 of the torsion sensor 1 includes an optical radiation generator 5 preferably arranged to generate Infra-Red radiation in the range 1200 nm to 1700 nm. In preferred embodiments the optical radiation generator 5 generates substantially monochromatic optical radiation. Optical radiation generated by the generator unit 5 is output from an optical output thereof onto an optical guide 8, which may be an optical waveguide structure or an optical fibre, to an optical input port of an optical polariser unit 6. The optical polariser unit is arranged to output at an optical output thereof optical radiation in a selected state of polarisation for onward transmission by the optical waveguide 8 to a polarisation control unit 7 operable to adjustably vary the orientation of the plane of polarisation of the polarised optical radiation received thereby from the polarisation unit 6, and to output the result to the optical waveguide 8 and thence to input the polarised optical radiation to the end of the optical fibre 2 fixed to the fixing unit 9 optically nearmost the optical radiation means for guidance by the optical fibre 2 to the tilted fibre Bragg grating within it. Polarised optical radiation transmitted through the tilted fibre Bragg grating 3 is subsequently guided by the optical fibre 2 to the end thereof fixed to the other of the two fixing units 10, optically nearmost the optical detector unit 12. The end of the optical fibre in question is an optical communication with a length of optical guide, such as an optical waveguide or an additional length of optical fibre, which is, in turn, in optical communication with an optical input of the optical detector unit 12 for the purposes of guiding the transmitted polarised optical radiation to the optical detector unit.

The optical polariser unit 6 and the polarisation control unit 7 may be any suitable form or structure such as would be readily apparent to the skilled person. The optical detector unit 12 is arranged to generate an electrical signal representative of the intensity of the transmitted polarised optical radiation received thereby from the optical fibre 2. The optical detector unit also includes a signal processor unit (not shown) responsive to the aforementioned electrical detection signals to detect torsion in the optical fibre, and thereby torsion in the object to which the optical fibre is fixed or embedded, according to the detected intensity and corresponding detection signal.

FIG. 4 schematically illustrates a part of the optical output end of the optical fibre 2 of the torsion sensor 1, illustrated in FIG. 1, containing the tilted fibre Bragg grating discussed above. The optical fibre 2 is a clad optical fibre comprising a cladding part 39 enveloping a core part 40. The tilted fibre Bragg grating 3 is contained solely within the core part 40 of the optical fibre. The clad optical fibre is structured and arranged to be a single-mode optical fibre in respect of the optical radiation which the optical radiation means 4 of the torsion sensor, is arranged to produce. The tilted fibre Bragg grating is defined by a regular series of uniformly spaced grating fringes 300, each sharing the same shape, dimensions and structure, and each being spaced from an immediately neighbouring grating fringe by a separation common to all such fringes. Each grating fringe is a region within the material of the core part 40 of the optical fibre of substantially plane shape defining a thin continuous area, band or boundary of increased refractive index extending across the fibre core in full.

While, in practice, the grating fringes may deviate slightly from being exactly or truly flat/planar in dimension, they are substantially flat, or can be reasonably and accurately represented or considered to be flat in the main.

Tilted fibre Bragg gratings are distinguished in terms of, among other things, the “angle of tilt” of the grating fringes of which they are comprised. The angle of tilt of a tilted fibre Bragg grating may be defined as the angle subtended between the line drawn normal to the plane, or average plane, of a grating fringe, and the line drawn parallel to the longitudinal axis of the core part of the optical fibre at the grating fringe in question. This angle is non-zero in a tilted fibre Bragg grating.

The periodic refractive index modulations thereby presented by the tilted fibre Bragg grating to guided optical radiation 41 incident upon it in the optical fibre core part 40, results in diffraction of the incident radiation, and a coupling thereof to modes of propagation outside the core part. Three coupling regimes are possible depending upon the angle of tilt of the grating fringes of the fibre grating, as follows.

If the angle of tilt of the tilted fibre Bragg grating were less than 45 degrees, diffraction at the grating would couple incoming guided core modes of optical radiation 41, from the core part of the optical fibre 2 and into counter-propagating cladding modes 42, confined to the cladding part of the optical fibre. If the angle of tilt were 45 degrees, then core modes 41 would be coupled by the grating into radiating modes 43, escaping from the outer surface of the cladding part of the optical fibre. In the embodiments of the invention described and illustrated herein, the angle of tilt of the tilted fibre Bragg grating exceeds 45 degrees, with the result that core modes 41 of optical radiation in the optical fibre are coupled by the grating into co-propagating cladding modes 44 with an efficiency which is highly dependent upon the state of polarization of the optical radiation, and the state of torsion of the optical fibre in question.

FIG. 5 schematically illustrates the dimensions of the grating fringes 300 of the tilted fibre Bragg grating 3 employed in the optical fibre 2 of the torsion sensor 1, of the embodiment of the invention illustrated in FIGS. 1 to 3.

With a core part 30 having a diameter of 7.93 μm, each of the grating fringes 300 of the tilted fibre Bragg grating, extends obliquely along the longitudinal axis of the core part for a distance of 67.33 μm, traversing the diameter of the core part in doing so. This results in an angle of tilt e of 81.3 degrees. The separation between neighbouring grating fringes is the “grating period, Λ, measured in the direction perpendicular to their planes, and is 4.03 μm in size. This structure is repeated along the core part 40 of the optical fibre 2 for a distance of I=10 mm, to define the length of the tilted fibre Bragg grating.

The greatest degree of core-to-cladding mode coupling, by the tilted fibre Bragg grating 3, occurs at wavelengths (λ_{co-cl}) of optical radiation satisfying the following condition:

$${λ}_{co - cl} = ( {n}_{co} \pm {n}_{cl , m} ) \cdot \frac{Λ}{cos θ} \qquad ( 1 )$$

Where n_{co} is the effective refractive index experienced by the fundamental core mode of the optical radiation in the optical fibre, and n_{cl,m} is the effective refractive index experienced by the m^{th} cladding mode of optical radiation in the optical fibre. The grating period of the tilted fibre Bragg grating is given by Λ, and θ is its tilt angle.

FIG. 6 graphically illustrates the optical transmission spectrum 60 of the optical fibre 2 (containing the tilted Bragg grating 3) of the torsion sensor 1, as a function of wavelength of un-polarised optical radiation transmitted thereby. A series of six broad, main transmission attenuation resonances 63 are displayed, corresponding to wavelengths of optical radiation at which the core modes of propagation are most efficiently coupled to successive cladding modes, in accordance with equation (1). It is noted that each main transmission attenuation resonance 63 comprises a mode-splitting sub-resonance structure, resulting in a double-trough resonance (61, 62) in each broad main attenuation resonance trough 63. This was found to occur in tilted fibre Bragg gratings with angles of tilt exceeding 45 degrees, and particularly having angles of tilt in the range of about 65 degrees to about 81 degrees, or more.

FIG. 7 graphically illustrates an optical transmission spectrum of the optical fibre 2 of the torsion sensor 1 in respect of optical radiation of each one of three different states of polarization, as a function of the wavelength of the transmitted optical radiation.

When optical radiation input to the optical fibre is randomly polarized, the transmission spectrum displays a split transmission attenuation resonance (trough) possessing a pair of two attenuation sub-resonances at positions within the spectrum spaced in wavelength (61, 62). However, it has been found that when the incident optical radiation is initially linearly polarized in one of two mutually orthogonal states of polarization (P1; P2, respectively), only one of the two attenuation sub-resonances is present in the transmission spectrum. while the other is substantially absent. With optical radiation in a first state of linear polarization (P1) e.g. in which the axis of polarization lies parallel to the plane of the grating fringes of the tilted fibre Bragg grating when the optical fibre is in a torsion-free state, the transmission spectrum of the optical fibre possess only one substantial attenuation resonance 74 centred at a wavelength λ1 coincident with that of the lower-wavelength sub-resonance 62 observed when polarization was random (i.e. un-polarized). No, or substantially no, attenuation sub-resonance is seen in the transmission spectrum at the higher-wavelength position λ2 where an attenuation sub-resonance 61 is otherwise seen under randomly polarized radiation. Conversely, the transmission spectrum of optical radiation in a state of linear polarization P2 orthogonal to that of P1, results in only one substantial transmission attenuation resonance 73 coincident with the wavelength position λ2 occupied by the higher-wavelength attenuation sub-resonance 61 occurring under randomly polarized optical radiation.

It is postulated that this sensitivity of the transmission properties of the optical fibre 2 is a polarization-induced interchanging coupling between birefringence modes in the titled Bragg grating. Optical radiation input to the tilted Bragg grating couples to a particular birefringence cladding mode of propagation with an efficiency, or strength, sensitively dependent upon the state of polarization of that radiation. It has been found that this polarization-sensitive birefringence mode-coupling is also sensitively dependent upon the state of torsion in the optical fibre 2.

FIG. 8 graphically illustrates a multitude of optical transmission spectra 90 of the optical fibre 2, in respect of optical radiation in the first state (P1) of linear polarization, as a function of wavelength, and for a multitude of different states of torsion (T) therein. Torsion is quantified in terms of the degree to which one end of the length L of the optical fibre 2 is rotated, about the longitudinal axis of the fibre, relative to the other end. This was achieved by rotating one of the two fixing units (9, 10) of the torsion sensor 1 about the longitudinal axis of the optical fibre, relative to the other fixing unit, the optical fibre 2 being held straight along its length L by the two fixing units in question.

In the quiescent state, with no torsion applied to the optical fibre 2 (i.e. T=0 degrees), the optical transmission spectrum of the optical fibre 91 reproduces that shown in FIG. 7 (curve 74) in respect of polarization state P1, displaying only a deep transmission attenuation resonance centred at optical wavelength λ1. When the torsion applied to the optical fibre reaches a value T=2T_{EQUAL} degrees (T_{EQUAL} being as defined above), the optical transmission spectrum of the optical fibre 92 has changed to resemble that of the optical fibre when subject to optical radiation in the state of polarization P2 orthogonal to that of P1, displaying only a deep transmission attenuation resonance centred at optical wavelength λ2 such as is shown in the spectrum 73 of FIG. 7. However, the state of polarization of optical radiation from which the optical transmission spectra 90, of FIG. 8, are derived, remains unchanged (i.e. polarization state P1).

Degrees of torsion intermediate T=0 degrees and T=2T_{EQUAL}, result in a transmission spectrum having a pair of transmission attenuation resonances of relative depths which depend upon the torsion T in a regular and predictable manner. The depth of the transmission attenuation resonance of the pair which predominates at low torsion values, reduces as torsion increases, and the depth of the other transmission attenuation resonance of the pair, which is small at low torsion values, increases under such circumstances.

At an applied torsion of T<T_{EQUAL}, the depth of the transmission attenuation resonance occurring at smaller wavelength (λ1), exceeds that which occurs at greater wavelength (λ2). The situation reverses as the magnitude of torsion applied to the fibre exceeds T_{EQUAL}. When the torsion applied to the optical fibre is substantially equal to T_{EQUAL}, the depth of the two attenuation resonances of the pair, at λ1 and λ2, are substantially equal.

FIG. 9 graphically illustrates the intensity of transmitted optical radiation detected by the optical detector unit 12 in response to the inputting to the optical fibre 2 of optical radiation generated by the optical radiation source in a constant, single state of polarization, P1, as defined above, measured at the two optical wavelengths (λ1, λ2) corresponding to the minima of the pair of transmission attenuation spectral sub-resonances (FIG. 8) of the optical fibre, with the optical fibre under a torsion (“twist angle”) varying from T=−2T_{EQUAL} to T=2T_{EQUAL} in torsion increments.

A quasi-sinusoidal relationship exists between the torsion applied to the optical fibre, and the measured intensity of transmitted radiation at a wavelength (λ1, λ2) coinciding with the minima of one of the pair of transmission attenuation sub-resonances (91, 92) associated with the transmission spectrum of the optical fibre.

The sinusoidal intensity.vs.torsion curve (100) associated with the first transmission attenuation sub-resonance (91) dominating the transmission spectrum (90) at low torsion values, has a minima at T=0 degrees with the optical fibre in the quiescent state. The curve is substantially symmetrical about this point, and rises (intensity increases) as the magnitude of the torsion T increases in either a positive sense (a clockwise twist) or a negative sense (an anti-clockwise twist).

The quasi-sinusoidal intensity.vs.torsion curve (101) associated with the second transmission attenuation sub-resonance (92) which dominates the transmission spectrum (90) at high torsion magnitudes, has a maximum at T=0 degrees with the optical fibre in the quiescent state. The curve is substantially symmetrical about this point, and falls (a decrease in intensity) as the magnitude of the torsion T increases in the positive or negative senses.

In preferred embodiments of the invention, the two fixing units (9,10) defining the length L of the optical fibre 2 to which torsion is applicable thereby, are arranged such that a torsion of T=T_{EQUAL} (or T=−T_{EQUAL}) is applied to the optical fibre in the absence of additional/external torsion or turning forces on the fibre from other than the two fixing units. The optical radiation source is arranged to produce substantially linearly polarized, monochromatic radiation, having a narrow bandwidth centred upon the wavelength (λ1,) coinciding with the position of the transmission minimum of the shorter-wavelength member of the transmission attenuation sub-resonance pair (91, 92). Alternatively, the optical radiation source may be arranged to produce radiation centred upon the position (λ2) of the longer-wavelength member of the transmission attenuation sub-resonance of the resonance pair.

An application of additional torsion to either of the first and second fixing units (9, 10) alone, will result in a change in the torsion to which the length L of optical fibre 2 is subjected (i.e. a change from T=T_{EQUAL}). Application of an external torsion to either one of the fixing units (9, 10) about the axis of the optical fibre in a positive sense, which urges to add to the fibre twist angle—results in detection of an increase in transmitted optical radiation intensity by the optical detector unit 12, which is arranged to produce a torsion detection signal accordingly. Conversely, application of an external torsion to either one of the fixing units (9, 10) about the axis of the optical fibre in a negative sense—which urges to subtract from the fibre twist angle—results in a detection of a decrease in transmitted optical radiation intensity at the optical detector unit 12. In alternative embodiments, in which the wavelength of optical radiation from the radiation source 5 is centred upon the minimum of the long-wavelength (λ2) attenuation sub-resonance (92) of the sub-resonance pair (91, 92), applied external torsion is similarly detected with a converse relation between applied torsion sense (clockwise/anti-clockwise) and a corresponding sense of change (increase/decrease) in detected transmitted radiation.

In simple embodiments, the optical detector unit 12 includes a threshold sensor operable to produce an electrical detection signal when the level of detected intensity falls below a predetermined or pre-set threshold value, or exceeds a predetermined or pre-set threshold value. In preferred embodiments, the magnitude of the electrical detection signal is dependent upon the magnitude of the external torsion resulting in the detected change in transmitted intensity. In such embodiments, the optical detector unit is arranged to calculate, using a signal processor unit (not shown) within the optical sensor unit, responsive to the electrical detection signals produced by the sensor unit 12, to produce a measure of the external torsion applied to the optical fibre according to stored pre-calibrated data empirically defining the relationship between the torque present in the optical fibre and the corresponding intensity of optical radiation transmitted thereby, such as is embodied in the curve of FIG. 9, for example.

In other embodiments of the invention, the optical detector 12 is arranged to detect the intensity of optical radiation transmitted through the tilted Bragg grating at a wavelength (λ1, λ2) at which transmission through the Bragg grating is minimised, at each one of two separate optical transmission attenuation sub-resonances (61, 62; 73, 74; 91, 92) in the collective optical transmission spectrum (60; 90) of the optical fibre 2 and Bragg grating 3. The optical detector is than arranged to detect torsion in the optical fibre 2 according to the two intensities so detected. The optical detector may be arranged to detect torsion in the optical fibre 2 according to the difference between the two intensities so detected, and/or according to the ratio thereof.

This use of two separate sub-resonances enables not only the magnitude of applied torsion to be determined, but also its sense/direction. FIG. 9 illustrates the intensity of polarised optical radiation transmitted through the tilted Bragg grating 3 and detected by the optical detector 12 at optical wavelengths (λ1; λ2) corresponding to the sub-resonance minima of each one of two sub-resonances in a pair of coupled such sub-resonances (73, 73) which split a common, main (broader) transmission attenuation resonance 63 in the collective transmission spectrum of the grating 3 and optical fibre 2. When the latter is under a torsion (e.g. a pre-torsion) of T_{EQUAL}, the detected intensity of optical radiation I₁ at the lower-wavelength (λ1) sub-resonance 91 is substantially equal to the detected intensity optical radiation I₂ at the upper-wavelength (λ2) sub-resonance 92 of the sub-resonance pair. The optical detector is arranged to determine the ratio (R=I₁/I₂) of the two detected intensities. When the optical fibre 2 is subject to a pre-torsion T₀ (e.g. T_{EQUAL}) then ratio R resulting from only the pre-torsion is R=R₀. When the optical fibre is subject to a net torsion T differing from the pre-torsion, which occurs when external torsion is applied to the torsion sensor, then R<R₀ if the externally applied torsion acts against the pre-torsion in direction/sense. When the optical fibre is subject to a net torsion differing from the pre-torsion as a result of an external torsion acting with the pre-torsion in direction/sense, then R>R₀. Thus, by determining the ration R and comparing it to R₀, the optical sensor may determine not only the magnitude of the externally applied torsion, but also its direction/sense relative to that of the pre-torsion.

For a example, consider a pre-torsion of T_{EQUAL} in the optical fibre 2 of the torsion sensor 1. FIG. 9 illustrates that the R₀=1. An applied external torsion of 0.333T_{EQUAL} causes the ratio R=I₁/I₂=350/175=2>R₀ thus denoting an external torsion co-acting with the pre-torsion. Conversely, an applied external torsion of −0.333T_{EQUAL} causes the ratio R=I₁/I₂=175/320=0.55<R₀ thus denoting an external torsion acting against the pre-torsion.

In a further example of the invention, the tilted fibre Bragg grating 3 was UV-inscribed in a hydrogen-loaded standard Corning SMF-28 fibre using a frequency-doubled Ar laser and phase mask scanning technique. A custom-designed mask of 6.6 m period was purchased from Edmund Optics to ensure that the spectral transmission attenuation resonance of the grating was positioned in the range of wavelengths of optical radiation of 1200 nm to 1700 nm. The tilted structures were realized by rotating the mask with respect to the fibre axis during the inscription of the fibre.

In the further example, a 96 mm intermediate length of a 1.5 m long optical fibre was inscribed with a 10 mm long tilted fibre Bragg grating mid-way along its length. The tilt angle was 81°. The intermediate (twistable) length of optical fibre was fixed by a clamp at one end and attached to a fibre rotator at the other end. The clamp and the fibre rotator were each attached to a common support frame. In order to eliminate measurement errors from axial-strain and bending effects, a small axial tension was applied to the fibre maintaining it straight.

In FIG. 8, the λ1 and λ2 transmission attenuation sub-resonance minima move in opposite directions under increasing degrees of twist. The wavelength spacing between the two minima increased from 6.33 nm to 7.82 nm when the intermediate length of optical fibre was twisted from 0° to 2T_{EQUAL} about its longitudinal axis.

In FIG. 9, two quasi-sinusoidal curves of opposite phases, are shown. A highly linear range of sensitivity to applied twist angles is seen within a broad range of angles extending to ±2/3×T_{EQUAL} (i.e. 4/3×T_{EQUAL} in extend), centred at a twist angle of either T_{EQUAL} or −T_{EQUAL}. This gives a twist sensitivity of 14.3 W/(rad/m). This embodiment of the torsion sensor enables detection of both the direction and amplitude of the torsion if the initial operation state is set at a pre-torsion of +T_{EQUAL} or −T_{EQUAL}. In the further example, T_{EQUAL}=±90°.

Thus, torsion may be easily monitored by a simple and low-cost intensity measurement interrogation system involving only a single wavelength source and a photo-detector. Using a standard photo-detector with a minimum detection power of 1 nW, the sensor may detect a twist rate change as small as 7.0×10⁻⁵(rad/m). This device may be used as an angle sensor which can detect an angular change as small as 3.8×10⁻⁴ degrees.

Coupled with its embedability, such in-waveguide twist sensors may find applications of structure deformation monitoring in many industrial sectors.

It will be appreciated that the examples given above are not intended to be limiting and variations of, and modifications to, the examples—such as would be readily apparent to the skilled person—are encompassed in the invention.

1-53. (canceled)

54. A torsion sensor comprising:
an optical waveguide containing a tilted Bragg grating having a tilt angle greater than 45°, the optical waveguide being arranged to guide optical radiation to the tilted Bragg grating;
an optical radiation means arranged to generate polarised optical radiation and input the generated polarised optical radiation to the optical waveguide for guidance thereby to the tilted Bragg grating; and
an optical detector arranged to detect the intensity of optical radiation transmitted through the tilted Bragg grating from the optical radiation means, whereby the sensor is arranged to detect torsion in the optical waveguide based on the detected intensity of the transmitted optical radiation.

55. The torsion sensor according to claim 54, wherein the optical radiation means is arranged to provide the optical radiation in a linearly polarised state.

56. The torsion sensor according to claim 55, wherein the tilted Bragg grating has a plurality of grating fringes and the optical radiation means is arranged to orient the linearly polarised optical radiation such that when the optical waveguide is in a quiescent state the axis of polarisation of optical radiation guided to the tilted Bragg grating is either
(i) substantially parallel to the grating fringes of the tilted Bragg grating, or
(ii) tilted relative to the grating fringes by an angle substantially equal in size to the angle of tilt of the grating fringes of the tilted Bragg grating.

57. The torsion sensor according to claim 54 in which the optical detector is arranged to determine the wavelength of the optical radiation at which transmission thereof through the tilted Bragg grating is minimised at each of two separate optical transmission attenuation resonances in the collective optical transmission spectrum of the optical waveguide and tilted Bragg grating, and to detect torsion in the optical waveguide according to a change in either said wavelength so determined.

58. The torsion sensor according to claim 54 in which the optical detector is arranged to detect the intensity of transmitted optical radiation having a wavelength at which transmission thereof through the tilted Bragg grating is minimised at each of two separate optical transmission attenuation resonances in the collective optical transmission spectrum of the optical waveguide and tilted Bragg grating, and to detect torsion in the optical waveguide according to the two intensities so detected.

59. The torsion sensor according to claim 58, wherein the optical detector is arranged to detect torsion in the optical waveguide according to either
(i) a difference between the two intensities so detected; or
(ii) a ratio of the two intensities so detected.

60. The torsion sensor according to claim 58, wherein each of said two separate optical transmission attenuation resonances forms one of a pair of coupled sub-resonances splitting a main optical transmission attenuation resonance, each of the sub-resonances being associated with a separate respective main resonance, one of the separate sub-resonances being one of a first pair of sub-resonances splitting a first main optical transmission attenuation resonance occurring at an optical wavelength less than the optical wavelength at which occurs the other sub-resonance of the first pair, and the other of the separate sub-resonances being one of a second pair of sub-resonances splitting a second main optical transmission attenuation resonance occurring at an optical wavelength greater than the optical wavelength at which occurs the other sub-resonance of the second pair.

61. The torsion sensor according to claim 54, wherein the optical waveguide and tilted Bragg grating are structured and arranged to have a collective optical transmission spectrum possessing an attenuation resonance, and wherein the optical radiation means is arranged to generate substantially monochromatic optical radiation having a wavelength within the bandwidth of the attenuation resonance.

62. The torsion sensor according to claim 54 including two separate fixing means attached to the optical waveguide between the optical radiation means and the optical detector to define therebetween an intermediate length of the optical waveguide, each one of the two fixing means being adapted to be simultaneously fixed independently to an object(s) other than the optical waveguide whereby a torsion in or between the object(s) about the axis of the intermediate length of optical waveguide is transmissible to the intermediate length of optical waveguide.

63. The torsion sensor according to claim 62, wherein the two separate fixing means apply a predetermined torsion to the intermediate length of optical waveguide.

65. The torsion sensor according to claim 54 wherein a length of the optical waveguide is embedded in an object whereby a torsion in the object about the axis of the embedded length of optical waveguide is transmissible to the length of embedded optical waveguide.

65. A method of detecting torsion, the method comprising:
inputting polarised optical radiation to an optical waveguide for guidance thereby to a tilted Bragg grating having a tilt angle greater than 45°;
detecting the intensity of the polarised optical radiation that is transmitted through the tilted Bragg grating; and
detecting torsion in the optical waveguide based on the detected intensity of the transmitted optical radiation.

66. The method according to claim 65, wherein
detecting the intensity of the polarised optical radiation includes detecting the intensity of transmitted optical radiation having a wavelength at which transmission thereof through the tilted Bragg grating is minimised at each of two separate optical transmission attenuation resonances in the collective optical transmission spectrum of the optical waveguide and tilted Bragg grating; and
detecting torsion in the optical waveguide is based on the two intensities so detected.

67. The method according to claim 66, wherein detecting torsion in the optical waveguide is based on either
(i) a difference between the two intensities so detected; or
(ii) a ratio of the two intensities so detected.

68. The method according to claim 66, wherein each of said two separate optical transmission attenuation resonances forms one of a pair of coupled sub-resonances splitting a main optical transmission attenuation resonance, each of the sub-resonances being associated with a separate respective main resonance, one of the separate sub-resonances being one of a first pair of sub-resonances splitting a first main optical transmission attenuation resonance occurring at an optical wavelength less than the optical wavelength at which occurs the other sub-resonance of the first pair, and the other of the separate sub-resonances being one of a second pair of sub-resonances splitting a second main optical transmission attenuation resonance occurring at an optical wavelength greater than the optical wavelength at which occurs the other sub-resonance of the second pair.
